(19) United States
(12) Patent Application Publication
(10) Pub. No.: US 2025/0296166 A1
(43) Pub. Date: Sep. 25, 2025

(54) GRINDING SYSTEM AND METHOD FOR CONTROLLING GRINDING SYSTEM

(71) Applicant: HONDA MOTOR CO., LTD., TOKYO (JP)

(72) Inventors: Naoki IWASA, TOKYO (JP); Daisuke YOSHIDA, TOKYO (JP); Tetsuya SHINOHARA, TOKYO (JP); Junichi NISHIYAMA, TOKYO (JP)

(21) Appl. No.: 19/064,065

(22) Filed: Feb. 26, 2025

(30) Foreign Application Priority Data
Mar. 21, 2024 (JP) 2024-044409

(51) Int. Cl. B23F 23/12; B23F 1/02

(52) U.S. Cl. CPC B23F 23/1218; B23F 1/023

(57) ABSTRACT

A grinding system includes a grinding device that meshes and synchronously rotates a gear-shaped workpiece and a grinding tool, thereby grinding a workpiece tooth surface of the workpiece with a helical grinding tooth surface of the grinding tool, an information acquisition unit configured to acquire information indicating a synchronization error between the workpiece and the grinding tool during grinding of the workpiece tooth surface, and a determination unit configured to determine, based on the synchronization error, whether an abnormality has occurred in the grinding of the workpiece tooth surface.

### CROSS-REFERENCE TO RELATED APPLICATIONS

This application is based upon and claims the benefit of priority from Japanese Patent Application No. 2024-044409 filed on Mar. 21, 2024, the contents of which are incorporated herein by reference.

### BACKGROUND OF THE INVENTION

### Field of the Invention

The present disclosure relates to a grinding system and a method for controlling the grinding system.

### Description of the Related Art

JP 5467833 B2 discloses a grinding system equipped with a grinding device that meshes and rotates a gear-shaped workpiece and a grinding tool and thereby grinds a workpiece tooth surface of the workpiece with a helical grinding tooth surface of the grinding tool.

### SUMMARY OF THE INVENTION

A better grinding system and a better method for controlling the grinding system are long-awaited.

The present disclosure aims to solve the aforementioned problems.

A first aspect of the present disclosure is a grinding system including a grinding device that meshes and synchronously rotates a gear-shaped workpiece and a grinding tool, thereby grinding a workpiece tooth surface with a helical grinding tooth surface of the grinding tool, an information acquisition unit configured to acquire information indicating a synchronization error between the workpiece and the grinding tool during grinding of the workpiece tooth surface, and a determination unit configured to determine, based on the synchronization error, whether an abnormality has occurred in the grinding of the workpiece tooth surface.

A second aspect of the present disclosure is a method for controlling a grinding system including a grinding device that meshes and synchronously rotates a gear-shaped workpiece and a grinding tool, thereby grinding a workpiece tooth surface of the workpiece with a helical grinding tooth surface of the grinding tool, the method comprising: an information acquisition step of acquiring a signal indicating a synchronization error between the workpiece and the grinding tool during grinding of the workpiece tooth surface; and a determination step for determining whether an abnormality has occurred in the grinding of the workpiece tooth surface, based on the synchronization error.

According to the present disclosure, a better grinding system and method for controlling the grinding system is provided.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a perspective view showing an example of a grinding system according to an embodiment;

FIG. 2 is a control block diagram for the grinding system;

FIG. 3 is a flowchart showing one example of a method for controlling the grinding system;

FIG. 4 is a graph for explaining a determination step; and

FIG. 5 is a graph for explaining the determination step.

### DETAILED DESCRIPTION OF THE INVENTION

In recent years, efforts to realize a low-carbon or decarbonized society have become active, and research and development on electric vehicles (hybrid vehicles, fuel cell vehicles, etc.) has been conducted to reduce CO₂ emissions and improve energy efficiency. Such electric vehicles have a smaller engine sound compared to conventional general gasoline fueled vehicles. Therefore, electric vehicles are required to reduce the noise generated during the rotation of gears more than gasoline fueled vehicles. In order to reduce the noise generated during the rotation of the gear, the tooth surface of a workpiece must be ground with good accuracy. If abnormalities occur in the grinding of the tooth surface of the workpiece, the tooth surface of the workpiece cannot be ground with high accuracy. Abnormalities in the grinding of the workpiece tooth surface can occur, for example, due to vibrations of a specific part of a grinding device during the grinding of the workpiece tooth surface. By measuring one by one the shape or the like of tooth surfaces of gear products obtained after the workpiece tooth surfaces of the workpieces are ground, it is possible to confirm whether the workpiece tooth surfaces of the workpieces have been ground with good accuracy. However, in this case, an apparatus for measuring the shape of the tooth surfaces of the product gears is required and in addition a large number of steps are required.

The inventors of the present application have found that a synchronization error between the workpiece and the grinding tool correlates with the grinding accuracy of the tooth surface of the workpiece in a case that the workpiece tooth surface of the workpiece is ground with the grinding tooth surface while the workpiece and the grinding tool are synchronously rotated. The present disclosure can provide a grinding system and a method for controlling the grinding system that can focus on such a correlation and conveniently perform abnormality determination for the grinding of a workpiece tooth surface.

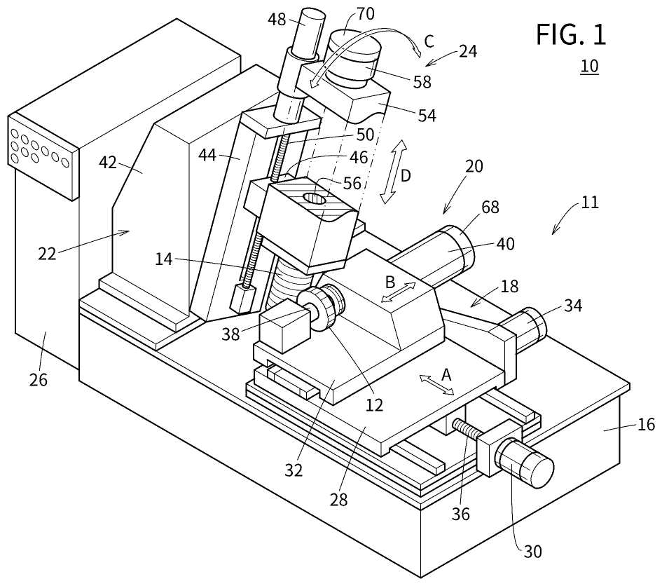

FIG. 1 is a perspective view showing an example of a grinding system 10 according to an embodiment. As shown in FIG. 1, the grinding system 10 includes a grinding device 11 and a controller 26. The grinding device 11 grinds a gear-shaped workpiece 12 with a grinding tool 14. The grinding device 11 includes a bed 16, a gear support mechanism 18, a gear rotation mechanism 20, a tool support mechanism 22, and a tool rotation mechanism 24.

The bed 16 is placed, for example, on a horizontal surface of a factory or the like. The gear support mechanism 18 is disposed on a flat upper surface of the bed 16. The gear support mechanism 18 includes a cutting table 28, a cutting motor 30, a traverse table 32, and a traverse motor 34.

The cutting table 28 moves in the A direction with respect to the bed 16. The A direction is a horizontal direction perpendicular to the height direction of the bed 16. The cutting table 28 is connected to the cutting motor 30 via a ball screw shaft 36. The cutting motor 30 moves the cutting table 28 in the A direction by rotating the ball screw shaft 36.

The traverse table 32 is disposed on an upper surface of the cutting table 28. The traverse table 32 moves in the B direction with respect to the cutting table 28. The B direction is a direction perpendicular to the height direction of the bed 16 and the A direction. The traverse table 32 is coupled to the traverse motor 34 via a ball screw shaft (not shown). The traverse motor 34 moves the traverse table 32 in the B direction by rotating the ball screw shaft.

The gear rotation mechanism 20 is arranged on an upper surface of the traverse table 32. The gear rotation mechanism 20 has a gear mounting shaft 38 and a first motor 40. The gear mounting shaft 38 extends in the B direction. The workpiece 12 is attachable to and detachable from the gear mounting shaft 38. The first motor 40 rotates the gear mounting shaft 38.

The tool support mechanism 22 includes a column 42, a pivot table 44, a shift table 46, and a shift motor 48. The column 42 is positioned on the upper surface of the bed 16 so as to face the gear support mechanism 18. The column 42 extends upward from the bed 16. The pivot table 44 is attached to a surface of the column 42 facing the gear support mechanism 18.

The pivot table 44 extends in one direction. A turning motor (not shown) turns the pivot table 44 in the C direction with respect to the column 42. The shift table 46 is provided on a surface of the pivot table 44 facing the gear support mechanism 18. The shift table 46 is coupled to the shift motor 48 via a ball screw shaft 50. The shift motor 48 is attached to the pivot table 44. The shift motor 48 moves the shift table 46 in the D direction with respect to the pivot table 44.

The tool rotation mechanism 24 includes a base 54, a tool mounting shaft 56, and a second motor 58. The base 54 is attached to a surface of the shift table 46 facing the gear support mechanism 18. The base 54 extends along the direction in which the pivot table 44 extends. The tool mounting shaft 56 is inserted through the base 54 along the direction in which the base 54 extends. The grinding tool 14 is attachable to and detachable from the tool mounting shaft 56. The second motor 58 rotates the tool mounting shaft 56.

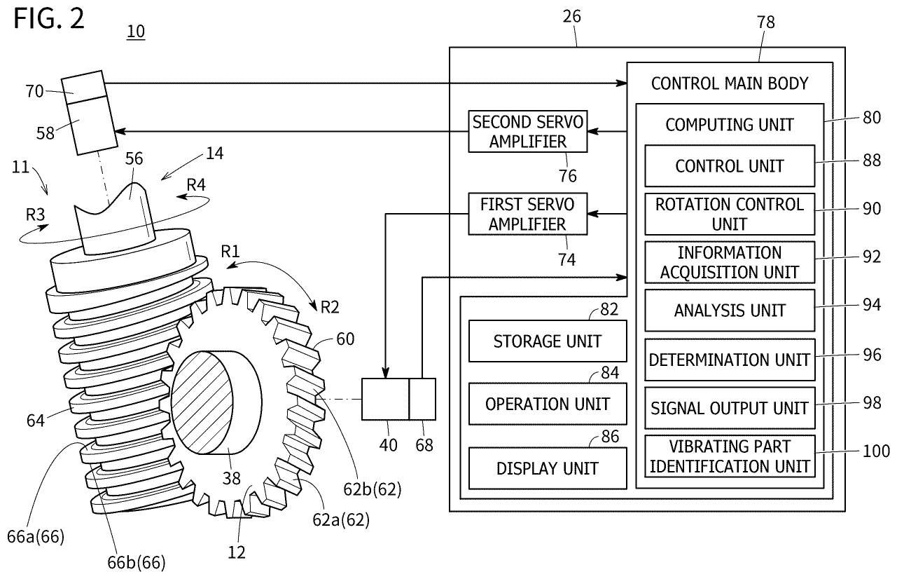

As shown in FIG. 2, the workpiece 12 is mounted on the gear mounting shaft 38. The workpiece 12 can be rotated in the R1 direction and the R2 direction by the driving force of the first motor 40. The workpiece 12 has a plurality of teeth 60. Each of the teeth 60 is formed with a workpiece tooth surface 62. The workpiece tooth surface 62 includes a left workpiece tooth surface 62a and a right workpiece tooth surface 62b.

The grinding tool 14 is mounted on the tool mounting shaft 56. The grinding tool 14 can be rotated in the R3 and R4 directions by the driving force of the second motor 58. The grinding tool 14 is a tool for grinding the workpiece 12. The grinding tool 14 has helical grinding teeth 64. A grinding tooth surface 66 is formed on the grinding teeth 64. The grinding tooth surface 66 includes a first grinding tooth surface 66a and a second grinding tooth surface 66b. For example, single-layer CBN (cubic boron nitride) abrasive grains or the like are electrodeposited on the grinding tooth surface 66 via a nickel plating layer.

When the workpiece 12 is ground by the grinding tool 14, the workpiece 12 and the grinding tool 14 are meshed with each other. With the workpiece 12 and the grinding tool 14 meshed, the left workpiece tooth surface 62a faces the first grinding tooth surface 66a, and the right workpiece tooth surface 62b faces the second grinding tooth surface 66b. With the workpiece 12 and the grinding tool 14 meshed with each other, the workpiece 12 is rotated in the R1 direction and the grinding tool 14 is rotated in the R3 direction, for example, whereby the left workpiece tooth surface 62a can be ground by the first grinding tooth surface 66a and the right workpiece tooth surface 62b can be ground by the second grinding tooth surface 66b. With the workpiece 12 and the grinding tool 14 meshed with each other, the workpiece 12 is rotated in the R2 direction and the grinding tool 14 is rotated in the R4 direction, for example, whereby also the left workpiece tooth surface 62a can be ground by the first grinding tooth surface 66a and the right workpiece tooth surface 62b can be ground by the second grinding tooth surface 66b.

The grinding device 11 further includes a first encoder 68 and a second encoder 70. The first encoder 68 is provided in a state of being coupled to the rotation shaft of the first motor 40. The first encoder 68 outputs to the controller 26 information (e.g., pulse signals) on the rotation phase (rotation speed, rotation angle, rotation position, rotation amount) of the workpiece 12.

The second encoder 70 is provided in a state of being coupled to the rotation shaft of the second motor 58. The second encoder 70 outputs to the controller 26 information (e.g., pulse signals) on the rotation phase (rotation speed, rotation angle, rotation position, and rotation amount) of the grinding tool 14.

The controller 26 includes a first servo amplifier 74, a second servo amplifier 76, and a control main body 78. The first servo amplifier 74 controls the rotation of the first motor 40 based on signals output from the control main body 78. The second servo amplifier 76 controls the rotation of the second motor 58 based on signals output from the control main body 78.

The control main body 78 includes a computing unit 80, a storage unit 82, an operation unit 84, and a display unit 86. The computing unit 80 is composed of a processor such as a CPU (Central Processing Unit) or a GPU (Graphics Processing Unit). That is, the computing unit 80 is formed by processing circuitry.

The computing unit 80 includes a control unit 88, a rotation control unit 90, an information acquisition unit 92, an analysis unit 94, a determination unit 96, a signal output unit 98, and a vibrating part identification unit 100. The control unit 88 controls the cutting motor 30, the traverse motor 34, a turning motor (not shown), and the shift motor 48. The rotation control unit 90 controls the rotation of the workpiece 12 via the first servo amplifier 74. The rotation control unit 90 controls the rotation of the grinding tool 14 via the second servo amplifier 76. The rotation control unit 90 controls the rotation of the workpiece 12 so that the rotation of the workpiece 12 is synchronized with the rotation of the grinding tool 14. The information acquisition unit 92 acquires information indicating a synchronization error between the workpiece 12 and the grinding tool 14. The analysis unit 94 analyzes the information acquired by the information acquisition unit 92. The determination unit 96 judges whether an abnormality has occurred in the grinding of the workpiece tooth surface 62 based on the synchronization error. The signal output unit 98 outputs an abnormality signal. The vibrating part identification unit 100 identifies a vibration part of the grinding device 11 based on the determination result of the determination unit 96.

The control unit 88, the rotation control unit 90, the information acquisition unit 92, the analysis unit 94, the determination unit 96, the signal output unit 98, and the vibrating part identification unit 100 can be realized by the computing unit 80 executing programs stored in the storage unit 82. At least part of the control unit 88, the rotation control unit 90, the information acquisition unit 92, the analysis unit 94, the determination unit 96, the signal output unit 98, and the vibrating part identification unit 100 may be realized by an integrated circuit such as an ASIC (Application Specific Integrated Circuit), an FPGA (Field-Programmable Gate Array) or the like. In addition, at least part of the control unit 88, the rotation control unit 90, the information acquisition unit 92, the analysis unit 94, the determination unit 96, the signal output unit 98, and the vibrating part identification unit 100 may be configured by an electronic circuit including discrete devices.

The storage unit 82 is composed of a volatile memory (not shown) and a nonvolatile memory (not shown). Examples of the volatile memory include, for example, a RAM (Random Access Memory) or the like. The volatile memory is used as working memory of a processor to temporarily store data or the like required for processing or computing operations. Examples of the nonvolatile memory include, for example, a ROM (Read Only Memory), a flash memory, or the like. The non-volatile memory is used as memory for storage, storing programs, tables, maps, etc. At least part of the storage unit 82 may be provided in the above-described processor, integrated circuit, etc.

The operation unit 84 is used when a user operates the controller 26. The operation unit 84 may include a keyboard, a mouse, and the like. The display unit 86 is provided with a display element (not shown). As the display element, for example, a liquid crystal display element, an organic electroluminescence display element, or the like is used. The operation unit 84 and the display unit 86 may be configured by a touch panel (not shown) provided with such a display element.

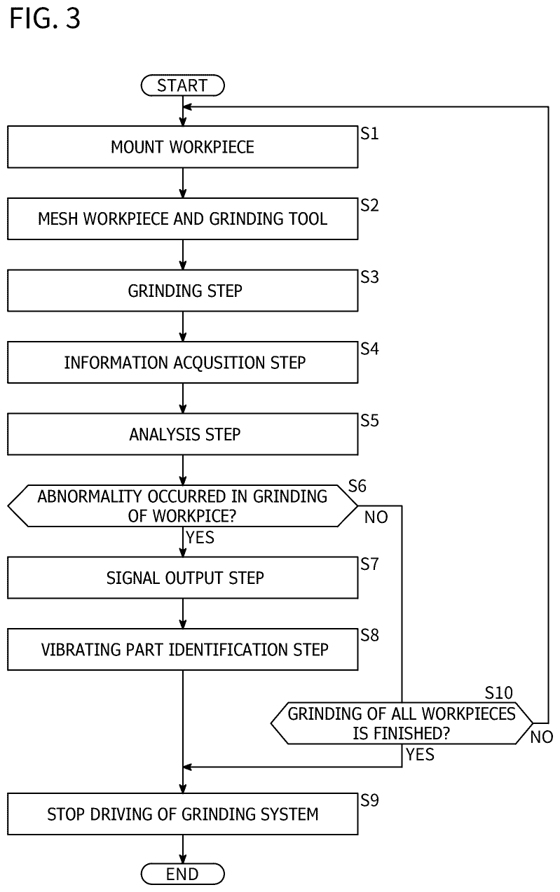

Next, an example of a method for controlling the grinding system 10 will be described. FIG. 3 is a flowchart illustrating an example of a method for controlling the grinding system 10. In the initial state, the grinding tool 14 is mounted on the tool mounting shaft 56.

In step S1, the workpiece 12 is mounted on the gear mounting shaft 38. Thereafter, the process transitions to step S2.

In step S2, the workpiece 12 and the grinding tool 14 are meshed with each other. Specifically, the control unit 88 controls the cutting motor 30, the traverse motor 34, the turning motor (not shown), and the shift motor 48 to mesh the workpiece 12 with the grinding tool 14. Thereafter, the process transitions to step S3.

In step S3, a grinding step is performed. In the grinding step, the workpiece tooth surface 62 is ground by the grinding tooth surface 66. The rotation control unit 90 rotates the workpiece 12 via the first servo amplifier 74 and rotates the grinding tool 14 via the second servo amplifier 76. The rotation control unit 90 rotates the workpiece 12 and the grinding tool 14 synchronously. In other words, the rotation control unit 90 controls the first servo amplifier 74 and the second servo amplifier 76 using feedback in a manner so that the workpiece 12 and the grinding tool 14 rotate maintaining the engaged state, based on the information output from the first encoder 68 and the information output from the second encoder 70. The rotation control unit 90 may take in, as the synchronization signal, information (the traverse speed of the workpiece 12 in the tooth width direction) output from an encoder provided in the traverse motor 34 to perform control. In the grinding step, grinding is performed over the circumference of the workpiece 12 (on all the workpiece tooth surfaces 62). In the grinding step, the workpiece tooth surface 62 can be subjected to grinding (e.g., first rough grinding, second rough grinding, and finishing grinding) multiple times. Thereafter, the process transitions to step S4.

In step S4, an information acquisition step is performed. In the information acquisition step, the information acquisition unit 92 acquires a signal indicating a synchronization error between the workpiece 12 and the grinding tool 14 during grinding of the workpiece tooth surface 62. The information acquisition step may be performed in parallel during the grinding step. Specifically, the information acquisition step acquires, as information indicating the synchronization error, phase difference data between the rotation phase of the workpiece 12 detected by the first encoder 68 and the rotation phase of the grinding tool 14 detected by the second encoder 70. The phase difference data is, for example, an accumulated pulse. Thereafter, the process transitions to step S5.

In step S5, an analysis step is performed. In the analysis step, the analysis unit 94 obtains analysis data by performing frequency analysis on the phase difference data. Specifically, the analysis unit 94 obtains the analysis data by applying the fast Fourier transform to the phase difference data. Thereafter, the process transitions to step S6.

In step S6, the determination unit 96 performs, based on the synchronization error, a determination step of determining whether or not an abnormality has occurred in the grinding of the workpiece tooth surface 62. That is, in the determination step, it is determined that an abnormality has occurred in the grinding of the workpiece tooth surface 62 when a peak value in the phase difference data included within a predetermined frequency band in the analysis data is equal to or larger than a predetermined threshold given for the frequency band.

In this embodiment, a plurality of frequency bands can be determined in advance according to the natural frequencies of a plurality of parts of the grinding device 11 where the occurrence of vibration is expected. Specifically, as the frequency bands, the first frequency band and the second frequency band are determined in advance. The first frequency band corresponds to, for example, the natural frequency of the gear mounting shaft 38. The second frequency band corresponds to, for example, the natural frequency of the tool mounting shaft 56.

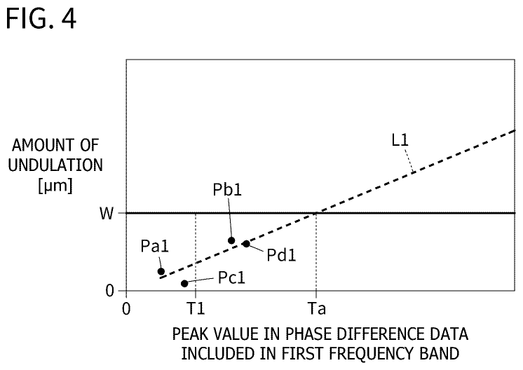

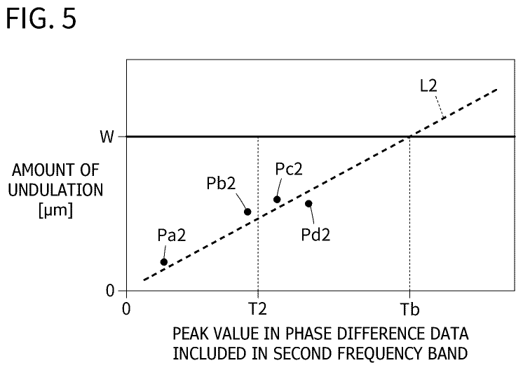

FIGS. 4 and 5 are graphs for explaining the determination step. In FIG. 4, the horizontal axis represents the peak value in the phase difference data included in the first frequency band whereas the vertical axis represents the amount of undulation of the tooth surface of the product gear obtained after the workpiece tooth surface 62 have been ground. As indicated by a broken line L1 in FIG. 4, the amount of undulation is proportional to the peak value in the phase difference data included in the first frequency band. The broken line L1 is obtained by performing a test in advance. In this case, the amount of undulation reaches an upper limit value W when the peak value in the phase difference data in the first frequency band is Ta. The upper limit value W is set as appropriate according to the shape and size of the product gear. In this embodiment, a first threshold T1 for the peak value in the phase difference data in the first frequency band is obtained by adding a safety factor to Ta. The first threshold T1 may be equal to Ta. In the determination step, the determination unit 96 determines that an abnormality has occurred in the grinding of the workpiece tooth surface 62 when the peak value in the phase difference data included in the first frequency band is equal to or larger than the first threshold T1.

In FIG. 5, the horizontal axis represents the peak value in the phase difference data included in the second frequency band whereas the vertical axis represents the amount of undulation of the tooth surface of the product gear obtained after the workpiece tooth surface 62 have been ground. As indicated by a broken line L2 in FIG. 5, the amount of undulation is proportional to the peak value in the phase difference data included in the second frequency band. The broken line L2 is obtained by performing a test in advance. In this case, the amount of undulation reaches the upper limit value W when the peak value in the phase difference data in the second frequency band is Tb. In this embodiment, a second threshold T2 for the peak value in the phase difference data in the second frequency band is obtained by adding a safety factor to Tb. The second threshold T2 may be equal to Tb. In the determination step, the determination unit 96 determines that an abnormality has occurred in the grinding of the workpiece tooth surface 62 when the peak value in the phase difference data included in the second frequency band is equal to or larger than the second threshold T2.

Specifically, for example, it is assumed here that as a result of the analysis in the analysis step, the peak value in the phase difference data included in the first frequency band is Pa1 whereas the peak value of the phase difference data included in the second frequency band is Pa2. Pa1 is smaller than the first threshold T1 (see FIG. 4), and Pa2 is smaller than the second threshold T2 (see FIG. 5). In this case, the determination unit 96 determines that no abnormality has occurred in the grinding of the workpiece tooth surface 62.

Further, it is assumed that as a result of analysis in the analysis step, the peak value in the phase difference data included in the first frequency band is Pb1 and the peak value in the phase difference data included in the second frequency band is Pb2. Pb1 is greater than the first threshold T1 (see FIG. 4) while Pb2 is less than the second threshold T2 (see FIG. 5). In this case, the determination unit 96 determines that an abnormality has occurred in the grinding of the workpiece tooth surface 62.

Further, it is assumed that as a result of analysis in the analysis step, the peak value in the phase difference data included in the first frequency band is Pc1 and the peak value in the phase difference data included in the second frequency band is Pc2. Pc1 is smaller than the first threshold T1 (see FIG. 4) while Pc2 is larger than the second threshold T2 (see FIG. 5). In this case, the determination unit 96 determines that an abnormality has occurred in the grinding of the workpiece tooth surface 62.

Further, it is assumed that as a result of analysis in the analysis step, the peak value in the phase difference data included in the first frequency band is Pd1 and the peak value in the phase difference data included in the second frequency band is Pd2. Pd1 is greater than the first threshold T1 (see FIG. 4) while Pd2 is greater than the second threshold T2 (see FIG. 5). In this case, the determination unit 96 determines that an abnormality has occurred in the grinding of the workpiece tooth surface 62.

That is, in the determination step, it is determined that an abnormality has occurred in the grinding of the workpiece tooth surface 62 when the peak value in the phase difference data is equal to or larger than the threshold in at least one frequency band. The above-described analysis and decision steps are performed each time the grinding step is completed. Also, the analysis and determination steps can be performed, for example, while the product gear is removed from the gear mounting shaft 38 and conveyed to the next process.

If it is determined in the determination step that an abnormality has occurred in the grinding of the workpiece tooth surface 62 (YES in step S6), the process shifts to step S7. In step S7, a signal output step is performed. In the signal output step, the signal output unit 98 outputs an abnormality signal indicating an abnormality in the grinding of the workpiece tooth surface 62. This allows, for example, a product gear in which a grinding anomaly has occurred to be removed from the production line based on the anomaly signal. Thereafter, the process transitions to step S8.

In step S8, a vibrating part identification step is performed. In the vibrating part identification step, the vibrating part identification unit 100 identifies a vibrating part of the grinding device 11 based on the determination result of the determination step. Specifically, if it is determined in the determination step that, for example, the peak value in the phase difference data included in the first frequency band is equal to or larger than the first threshold T1, the vibrating part identification unit 100 identifies a part (the gear mounting shaft 38) having the natural frequency corresponding to the first frequency band as the vibrating part. If it is determined in the determination step that, for example, the peak value in the phase difference data included in the second frequency band is equal to or larger than the second threshold T2, the vibrating part identification unit 100 identifies a part (the tool mounting shaft 56) having the natural frequency corresponding to the second frequency band as the vibrating part. The control unit 88 causes the display unit 86 to display information on the vibrating part identified by the vibrating part identification unit 100, for example. This enables the user to grasp the vibrating part and thus to perform appropriate processes such as investigation of the cause of vibration. Thereafter, the process transitions to step S9.

In step S9, the control unit 88 stops the driving of the grinding system 10. After this, the process of FIG. 3 is completed.

If it is determined in the determination step that no abnormality has occurred in the grinding of the workpiece tooth surface 62 (NO in step S6), the process shifts to step S10. In step S10, the determination unit 96 determines whether or not the grinding of all the workpieces 12 is finished. In other words, the determination unit 96 determines whether the grinding of a predetermined number of workpieces 12 (e.g., N workpieces 12) has been completed. When the determination unit 96 determines that grinding of all the workpieces 12 has not been finished (NO in step S10), the process shifts to step S1. When the determination unit 96 determines that the grinding of all the workpieces 12 is finished (YES in step S10), the process of FIG. 3 is completed after the process of step S9 is performed.

According to the present embodiment, it is determined whether an abnormality has occurred in the grinding of the workpiece tooth surface 62 based on the synchronization error between the workpiece 12 and the grinding tool 14. Thus, abnormality determination for the grinding of the workpiece tooth surface 62 can be performed simply and easily. Accordingly, a better grinding system 10 and method of controlling the grinding system 10 can be provided.

With respect to the above embodiments, the following supplementary notes are further disclosed.

(Supplementary note 1)

A grinding system (10) includes a grinding device (11) that meshes and synchronously rotates a gear-shaped workpiece (12) and a grinding tool (14), thereby grinding a workpiece tooth surface (62) of the workpiece with a helical grinding tooth surface (66) of the grinding tool, an information acquisition unit (92) configured to acquire information indicating a synchronization error between the workpiece and the grinding tool during grinding of the workpiece tooth surface, and a determination unit (96) configured to determine, based on the synchronization error, whether an abnormality has occurred in the grinding the workpiece tooth surface.

According to such a configuration, it is determined whether an abnormality has occurred in the grinding of the workpiece tooth surface, based on the synchronization error between the workpiece and the grinding tool. Thus, abnormality determination for the grinding of the workpiece tooth surface can be performed simply and easily. Thus, a better grinding system and method for controlling the grinding system can be provided.

(Supplementary note 2)

In the grinding system according to Supplementary note 1, the information acquisition unit may acquire, as the information indicating the synchronization error, phase difference data between a rotational phase of the workpiece detected by a first encoder (68) and a rotational phase of the grinding tool detected by a second encoder (70).

With such a configuration, information about synchronization errors can be easily acquired.

(Supplementary note 3)

The grinding system according to Supplementary note 2 may further include an analysis unit (94) configured to acquire analysis data by performing frequency analysis on the phase difference data, wherein the determination unit may determine that the abnormality has occurred in a case where a peak value of the phase difference data included within a predetermined frequency band in the analysis data acquired by the analysis unit is equal to or greater than a predetermined threshold (T1, T2) of the frequency band.

According to such a configuration, it can be determined with high accuracy whether an abnormality has occurred in the grinding of the workpiece tooth surface by using the peak value of the phase difference data included in a specific frequency band.

(Supplementary note 4)

In the grinding system according to supplementary note 3, the frequency band may be determined based on the natural frequency of a portion of the grinding device where vibration is expected to occur, and the grinding system may further include a vibration portion identification unit (100) configured to identify a vibration portion of the grinding device based on the determination result when the determination unit determines that the abnormality has occurred.

According to such a configuration, when an abnormality occurs in the grinding of the workpiece tooth surface due to vibration of a specific portion of the grinding device, the vibration portion can be easily identified. This enables the user to grasp the vibration portion and thus to perform appropriate processing.

(Supplementary note 5)

The grinding system according to any one of Supplementary notes 1 to 4 may further include a signal output unit (98) configured to output an abnormality signal indicating the abnormality in a case where the determination unit determines that the abnormality has occurred.

According to such a configuration, it is possible to perform, based on the abnormality signal output from the signal output unit, appropriate processing such as removing from a manufacturing line a product gear in which a grinding abnormality has occurred.

(Supplementary note 6)

A method for controlling a grinding system including a grinding device that meshes and synchronously rotates a gear-shaped workpiece and a grinding tool, thereby grinding a workpiece tooth surface of the workpiece with a helical grinding tooth surface of a grinding tool, the method comprising: an information acquisition step of acquiring a signal indicating a synchronization error between the workpiece and the grinding tool during grinding of the workpiece tooth surface; and a determination step for determining whether an abnormality has occurred in the grinding of the workpiece tooth surface, based on the synchronization error.

According to such a method, the same benefits as Supplementary note 1 are achieved. Thus, a better method for controlling the grinding system can be provided.

(Supplementary note 7)

In the control method for the grinding system according to Supplementary note 6, the information acquisition step may acquire, as the information indicating the synchronization error, phase difference data between a rotational phase of the workpiece detected by a first encoder and a rotational phase of the grinding tool detected by a second encoder.

According to such a method, the same benefits as Supplementary note 2 are achieved.

(Supplementary note 8)

In the method for controlling the grinding system according to supplementary note 7, in the determination step 1 it may be determined that the abnormality has occurred in a case where a peak value of the phase difference data included within a predetermined frequency band in analysis data acquired by performing frequency analysis on the phase difference data is equal to or larger than a predetermined threshold of the frequency band.

According to such a method, the same benefits as Supplementary note 3 are achieved.

(Supplementary note 9)

In the method for controlling the grinding system according to Supplementary note 8, wherein the frequency band is determined based on the natural frequency of a portion of the grinding device where vibration is expected to occur, and the method may further include a vibration portion identification step of identifying, in a case where it is determined that the abnormality has occurred, a vibration portion of the grinding device, based on the frequency band in which the peak value exceeding the threshold is included.

According to such a method, the same benefits as Supplementary note 4 are achieved.

(Supplementary note 10)

The method for controlling the grinding system according to any one of Supplementary notes 6 to 9 may further include a signal output step of outputting an abnormality signal indicating the abnormality in a case where it is determined by the determination step that the abnormality has occurred.

According to such a method, the same benefits as Supplementary note 5 are achieved.

Although the present disclosure has been detailed, the present disclosure is not limited to the individual embodiments described above. These embodiments may be variously added, replaced, altered, partially deleted, etc., without departing from the scope of the present disclosure or the intent of the present disclosure as derived from the claims and their equivalents. These embodiments can also be implemented in combination. For example, in the above-described embodiment, the order of the operations and the order of the processes are shown as an example, and are not limited to these. The same applies to the case where numerical values or mathematical expressions are used in the description of the above-described embodiment.

1. A grinding system comprising:
a grinding device that meshes and synchronously rotates a gear-shaped workpiece and a grinding tool, thereby grinding a workpiece tooth surface of the workpiece with a helical grinding tooth surface of the grinding tool; and
a controller that includes one or more processors executing computer-executable instructions stored in a memory,
wherein the one or more processors executes the computer-executable instructions to cause the controller to:
acquire information indicating a synchronization error between the workpiece and the grinding tool during grinding of the workpiece tooth surface; and
determine, based on the synchronization error, whether an abnormality has occurred in the grinding of the workpiece tooth surface.

2. The grinding system according to claim 1, wherein
the controller acquires, as the information indicating the synchronization error, phase difference data between a rotational phase of the workpiece detected by a first encoder and a rotational phase of the grinding tool detected by a second encoder.

3. The grinding system according to claim 2, wherein
the controller
acquires analysis data by performing frequency analysis on the phase difference data, and
determines that the abnormality has occurred in a case where a peak value of the phase difference data included within a predetermined frequency band in the analysis data acquired is equal to or larger than a predetermined threshold of the frequency band.

4. The grinding system according to claim 3, wherein
the frequency band is determined based on a natural frequency of a portion of the grinding device where vibration is expected to occur, and
in a case where it is determined that the abnormality has occurred, the controller identifies a vibration portion of the grinding device based on a determination result.

5. The grinding system according to claim 1, wherein
in a case where it is determined that the abnormality has occurred, the controller outputs an abnormality signal indicating the abnormality.

6. A method for controlling a grinding system including a grinding device that meshes and synchronously rotates a gear-shaped workpiece and a grinding tool, thereby grinding a workpiece tooth surface of the workpiece with a helical grinding tooth surface of the grinding tool, the method comprising:
acquiring a signal indicating a synchronization error between the workpiece and the grinding tool during grinding of the workpiece tooth surface; and
determining, based on the synchronization error, whether an abnormality has occurred in the grinding of the workpiece tooth surface.

7. The method for controlling the grinding system according to claim 6, further comprising
acquiring, as information indicating the synchronization error, phase difference data between a rotational phase of the workpiece detected by a first encoder and a rotational phase of the grinding tool detected by a second encoder.

8. The method for controlling the grinding system according to claim 7, further comprising
determining that the abnormality has occurred in a case where a peak value of the phase difference data included within a predetermined frequency band in analysis data acquired by performing frequency analysis on the phase difference data is equal to or larger than a predetermined threshold of the frequency band.

9. The method for controlling the grinding system according to claim 8, wherein
the frequency band is determined based on a natural frequency of a portion of the grinding device where vibration is expected to occur, and
the method further comprising identifying, in a case where it is determined that the abnormality has occurred, a vibration portion of the grinding device, based on the frequency band in which the peak value exceeding the threshold is included.

10. The method for controlling the grinding system according to claim 6, further comprising
outputting an abnormality signal indicating the abnormality in a case where it is determined that the abnormality has occurred.
